(19) United States
(12) Patent Application Publication
(10) Pub. No.: US 2009/0286206 A1
(43) Pub. Date: Nov. 19, 2009

(54) COSMETIC DENTAL STRUCTURES

(75) Inventor: Florian Braich, Palm Beach Gardens, FL (US)

Correspondence Address: THORPE NORTH & WESTERN, LLP., P.O. Box 1219, SANDY, UT, 84091-1219, US

(73) Assignee: PALM BEACH VENEERS, Palm Beach Gardens, FL (US)

(21) Appl. No.: 12/326,810

(22) Filed: Dec. 2, 2008

Related U.S. Application Data
(60) Provisional application No. 61/128,032, filed on May 19, 2008.

(51) Int. Cl. A61C 5/04; A61C 13/00

(52) U.S. Cl. 433/226; 433/201.1

(57) ABSTRACT

Compositions and methods are provided for a cosmetic dental structure, comprising a veneer body sized to cover at least a portion of a tooth structure. The veneer body has a front face and a reinforcement rib extending outwardly from a rear face of the veneer body. The reinforcement rib can be configured to strengthen the veneer body, and the reinforcement rib and veneer body are configured to be adhered to the tooth structure.

### CROSS-REFERENCE TO RELATED APPLICATIONS AND CLAIM OF PRIORITY

Priority to U.S. Provisional patent application Ser. No. 61/128,032 filed on May 19, 2008 is claimed and is hereby incorporated by reference in its entirety.

### BACKGROUND

Many times in dentistry, a patient will have teeth that he or she will consider aesthetically unpleasing. Typically these undesirable teeth are the visible teeth or front teeth that may display multiple restored areas, discolorations, uneven edges, congenital malformations, etc.

Dentists possess many restorative modalities to confront these various situations. They range from simply bleaching the teeth to fully covering the tooth with a crown. In some instances, the teeth are structurally sound and functional and do not need aggressive treatment. For these instances, dentists may elect to alter the external surface of the tooth by applying a cosmetic improvement to the tooth with minimal invasion or removal of sound tooth structure. For other instances, complete tooth restoration or cosmetic enhancements are also possible.

For example, one restorative modality can include dental porcelain bonded to an underlying metal substructure. The dental porcelain typically includes an opaque base layer, an intermediate layer of dentin porcelain, and an outer layer of enamel porcelain. In some cases, the metal substructure is covered with a bonding agent to promote bonding of the porcelain to the metal. The color of the completed restoration is a function of the color and opacity of the opaque, dentin, and enamel layers of the porcelain, the color of the metal substructure, and the color of the bonding agent in cases where it is used. In these restorations, the dental technician adjusts the color of the total restoration by adjusting the colors of each of the components of the restoration. Most often, the underlying metal substructure gives an unappealing grayish cast to the restoration, and attempts to hide the gray color result in a thicker and more opaque porcelain which tends to look unnatural when compared to the natural translucency of human teeth. This is particularly true in cases where very thin restorations are used.

Rather than using an entire dental restoration, dental veneers are sometimes used when it is desirable to replace worn-down portions of teeth or to attempt to provide a more desirable color to discolored teeth. There are various types of conventional dental veneers, which are typically made entirely of porcelain without the inclusion of a metal substructure. Specifically, conventional veneers generally have three porcelain layers: an opaque base layer, an intermediate layer of dentin porcelain, and an outer layer of enamel porcelain.

Minimally invasive cosmetic alterations of the tooth can be accomplished by placing a cover or veneer on the surface of the tooth which allows for altering both its shade and shape. Several types of veneers can be applied. For example, an indirect veneer can be used and is one that is fashioned extra-orally, typically in a dental laboratory. After tooth preparation, an impression is taken of the tooth and sent to the laboratory. The patient then returns for a subsequent visit to have the fabricated veneer inserted. Alternately, the veneer can be fabricated directly on the patient's prepared tooth, while the patient remains in the dental chair. Such a method is generally referred to as a direct veneer. The dentist generally possesses an array of composite resin restorative materials of various shades with which to apply to the tooth for the purpose of shade and or anatomical alteration of the prepared tooth. Typically, the dentist will dispense the appropriate shade and quantity of resin, and apply the dispensed mass directly to the prepared tooth and proceed to tamp down the mass to a uniform thickness while simultaneously manipulating the mass to conform to the outline of the prepared tooth. Accordingly, several methods of tooth restoration can be applied to treat various medical and/or aesthetical issues associated with teeth.

### SUMMARY OF THE INVENTION

In accordance with one embodiment of the present invention, a cosmetic dental structure can comprise a veneer body sized to cover at least a portion of a tooth structure. The veneer body can have a front face and have a rear face. Additionally, the veneer body can have a reinforcement rib extending outwardly from the rear face of the veneer body, the reinforcement rib being configured to strengthen the veneer body. Further, the reinforcement rib and veneer body can be configured to be adhered to the tooth structure.

In accordance with another embodiment of the present invention, a cosmetic dental structure can comprise a veneer body having a front face and a rear face with an attachment structure extending from the rear face of the veneer body. The attachment structure can be configured to increase the surface area of the rear face of the veneer body available when affixing the veneer body to a tooth structure.

Additionally, the present invention provides a method of increasing surface area on a veneer body for attachment to a tooth structure, comprising forming a reinforcement rib on a rear face of the veneer body. The reinforcement rib can extend from the rear face of the veneer body and can be configured to strengthen the veneer body.

In one embodiment of the invention, a method of manufacturing a cosmetic dental structure can comprise reducing a tooth structure to form a reduced tooth such that a front face of the tooth structure contains a recession configured to mate with a veneer body having a reinforced rib extending from a rear face of the veneer body and configured to strengthen the veneer body, and forming the veneer body wherein the size of the veneer body is configured to cover at least a portion of the reduced tooth and wherein the reinforced rib is configured to mate with the recession on the front face of the reduced tooth.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 illustrates a rear perspective view of a reinforced veneer in accordance with an embodiment of the present invention;

FIG. 2 illustrates a cross-sectional view of a reduced tooth having a reinforced veneer affixed thereto in accordance with an embodiment of the present invention;

FIG. 3 illustrates a front perspective view of a reduced tooth in accordance with an embodiment of the present invention;

FIG. 4 depicts a front perspective view of a reduced tooth in accordance with an embodiment of the present invention;

FIG. 5 illustrates a rear perspective view of a reinforced veneer in accordance with an embodiment of the present invention;

FIG. 6 illustrates a rear perspective view of a reinforced veneer in accordance with an embodiment of the present invention;

FIG. 7 illustrates a rear perspective view of a reinforced veneer in accordance with an embodiment of the present invention;

FIG. 8 illustrates a rear perspective view of a reinforced veneer in accordance with an embodiment of the present invention;

FIG. 9 illustrates a rear perspective view of a reinforced veneer in accordance with an embodiment of the present invention;

FIG. 10 illustrates a rear perspective view of a reinforced veneer in accordance with an embodiment of the present invention; and

FIG. 11 illustrates a flow chart of a method in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENTS

Before the present invention is disclosed and described, it is to be understood that this invention is not limited to the particular process steps and materials disclosed herein because such process steps and materials may vary somewhat. It is also to be understood that the terminology used herein is used for the purpose of describing particular embodiments only. The terms are not intended to be limiting because the scope of the present invention is intended to be limited only by the appended claims and equivalents thereof.

It must be noted that, as used in this specification and the appended claims, the singular forms “a,” “an,” and “the” include plural referents unless the context clearly dictates otherwise.

As used herein, “cosmetic dental structure” or “reinforced veneer” refers to a dental veneer having one or more reinforcement structures configured thereon.

As used herein, “tooth structure” refers to all or a portion of a natural tooth or synthetic tooth structure including bridges, crowns, implants, etc. A tooth structure includes natural or synthetic teeth that have been reduced, altered, or otherwise manipulated in the performance of dental work, and may include substances in dental procedures (e.g., dental porcelain, metal, or cement).

As used herein, “reinforcement rib” refers to any support structure used to strengthen a veneer or increase the surface area of the rear face of a veneer. As such, the reinforcement ribs' length can be elongated or shortened based on the desired result to be achieved. In addition, the width and shape of the reinforcement ribs may vary while still providing the desired strengthening results.

As used herein, “substantially” or “substantial” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking, the nearness of completion will be so as to have the same overall result as if absolute and total completion were obtained. The use of “substantially” is equally applicable when used in a negative connotation to refer to the complete or near complete lack of action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still contain such an item as long as there is no measurable effect thereof.

As used herein, “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

It has been recognized that it would be advantageous to develop a cosmetic dental structure having superior wear and strength characteristics. Specifically, the present inventors have recognized the need for an improved dental veneer for use in dentistry. In accordance with this, devices and structures having a reinforced veneer are provided herein. When discussing a reinforced veneer, the present specification discusses configurations of reinforced veneers and methods involving such reinforced veneers, and each of these discussions can be considered applicable to each of these embodiments, whether or not they are explicitly discussed in the context of that embodiment. For example, in discussing a reinforcement rib present on a veneer, those reinforcement ribs can also be used in a method for making such veneers, and vice versa.

In accordance with one embodiment of the present invention, a cosmetic dental structure can have a veneer body sized to cover at least a portion of a tooth structure. The veneer body can have a front face of the veneer body and a rear face for the veneer body. A reinforcement rib can extend outwardly from the rear face of the veneer body, and the reinforcement rib can be configured to strengthen the veneer body. Additionally, the reinforcement rib and veneer body can be configured to be adhered to the tooth structure.

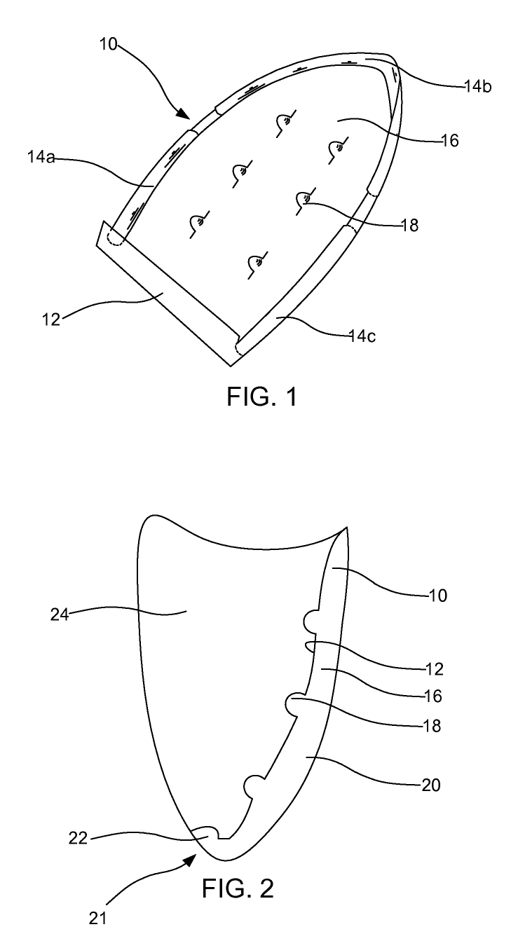

As illustrated in FIG. 1, a cosmetic structure 10 can comprise one or more reinforcement ribs 14a, 14b, and 14c extending from the rear face of the veneer body 16 along the edges of the veneer body 16. The reinforcement ribs 14a and 14c can be substantially elongated ribs positioned to match vertical interproximal aspects on the sides of the tooth structure. The reinforcement ribs 14a and 14c can be positioned to match non-gingival contours of the tooth structure. These vertical reinforcement ribs help reduce any tendency the dental veneer may have to develop horizontal cracks.

Additionally, the reinforcement rib 14b can be positioned to match a gingival contour of the tooth structure. This horizontal reinforcement rib helps to reduce the possibility of vertical cracks in the dental veneer. In addition, when one or more horizontal reinforcement ribs are combined with the structure created by an incisal reduction, this significantly increases the veneers resistance to vertical cracking.

While FIG. 1 identifies three separate reinforcement ribs 14a, 14b, and 14c, such ribs can also form a single rib positioned to match a gingival and non-gingival contour of the tooth structure, as discussed in further detail below. For example, the reinforced ribs 14a, 14b, and 14c can form a U-shape. Additionally, the rib 14b can be substantially U-shaped to match a gingival contour of a tooth structure and extend along the interproximal aspects on the sides of the tooth.

In one embodiment, the veneer body can comprise one reinforcement rib. In another embodiment, the veneer body can comprise at least two reinforcement ribs. In still another embodiment, the veneer body can comprise at least three reinforcement ribs. Such embodiments are not intended to be limiting, as one skilled in the art can envision a veneer body having a wide range of reinforcement ribs as well as alternate configurations of the reinforcement ribs on the veneer body.

The veneer body can be made from dental porcelain or other appropriate dental material, including any dental material approved by dental medicine governing boards to be used in the patients and showing permanent or temporary usage characteristics and displaying acceptable tooth-like aesthetics, e.g., porcelain, reinforced porcelain containing additional materials and/or chemical additives, zirconium, acrylics. The present cosmetic dental structures can be applied to any tooth structures including natural teeth, bridges, crowns, implants, etc. In one embodiment, the tooth structure is a natural tooth. Generally, a method of applying the cosmetic dental structures described herein to a tooth structure can comprise affixing the veneer body to the tooth structure. Such attachment can be accomplished by well-known means in the dentistry field. In one embodiment, dental cement is used to affix the veneer body to the tooth structure. However, any appropriate dental bonding material can be used including light cure bondings, dual cure bondings, and chemical and/or photosensitive adhesives. Additionally, such attachment can be made to various materials, including metal, ceramics, porcelain, natural tooth, as well as those materials used in dentistry. The cosmetic dental structure with reinforcement ribs can also provide increased surface area for attachment to a tooth structure as compared to a veneer that has a substantially flat surface.

The present cosmetic dental structures help reduce the cracking of the veneers that might otherwise take place when: the dental veneers are cemented onto a dental patient's teeth, following cementation, or during later use by a dental patient. Since there is a reduced chance of cracking as a result of the strength of these veneers, there is also a reduced chance of portions of the dental veneer being dislodged or the veneers being discolored due to the cracking or other breakage or infiltration of capillary suction of pigments.

Additionally, the present cosmetic dental structures have excellent adhesion to a tooth structure while using less adhesive material as the structures provided herein can interlock with a matched reduced tooth. The definitive positioning of the strengthened veneer structures also enables a dentist to more easily cement the dental veneer onto a patient's tooth with the proper alignment. Because of the increased adhesion strength, there is also a reduced chance of the veneer structure becoming completely dislodged from the patient's tooth.

The present veneers have excellent durability due to their overall strength. Such strength may also allow a thinner veneer to be used. Because a thinner veneer can be used, this means that the removal of an extensive amount of tooth material can be avoided, which avoids the deeper preparations used by previous dental veneer systems. In addition, these dental veneer structures provide a stronger veneer structure than can be provided by other veneer systems that use significantly less dental preparation. The thinner veneer avoids the bulkiness and negative response of periodontal tissue that is a result of using thicker veneers or non-prep veneers (the inevitable bulk of material at gingival margin) to avoid cracking in minimal preparation systems.

As illustrated in FIG. 1, the cosmetic dental structure 10 can further include additional attachment structures 18 extending from the rear face of the veneer body 16. Such attachment structures 18 can be configured to increase the surface area of the veneer body 16 when affixing the veneer body 16 to a tooth structure. Specifically, the attachment structures 18 can be formed in any shape. In one embodiment, the shape can be hemispherical. Such a shape can provide a larger surface area for the material removed as compared to many other geometric shapes and can be easily performed by existing dental drills. Additionally, the shape can be partially spherical or semispherical (i.e., roughly spherical). Notably, other shapes can be envisioned to increase surface area of the rear face of the veneer body 16, such as shapes that are more square or polygonal.

The veneer body 16 can also be configured to wrap around the incisal edge of the tooth structure 21 (FIG. 2) such that, along with reinforcement ribs 14a, 14b, and 14c, a reinforced frame is formed around one or more sides of the veneer body 16. The incisal edge of the tooth structure can include an incisal rib 22 (shown in FIG. 2). In one embodiment, the reinforcement rib 14a, 14b, and/or 14c can be a perimeter shaped rib positioned to match to corresponding non-gingival and gingival contours of the tooth structure 24 and a portion of the veneer is configured to wrap around an incisal edge of the tooth structure 21 (shown in FIG. 2) thereby forming a reinforced frame around the veneer body 16. In another embodiment, a reinforcement rib 14 is a perimeter shaped rib is positioned to match to corresponding non-gingival and gingival contours of the tooth structure, and a reinforced frame is formed around the veneer body using the incisal rib.

Using the configurations described, the surface area of cementation for a dental veneer can be almost doubled in some embodiments. Increasing the surface of cementation also reduces the possibility that an installed dental veneer will be dislodged from the patent's tooth structure. By using any cementation material, present or future, the increased surface of cementation results in increased bonding force to the substrate.

The cosmetic dental structures described herein can have any number of attachment structures with a variety of sizes and shapes. In one embodiment, the veneer body can have 1 to 12 or even more attachment structures. In another embodiment, the veneer body can have 4 to 10 attachment structures. In still another embodiment, the veneer body can have 6 to 8 attachment structures. As such, the veneer body can have attachment structures having substantially the same shape and/or sizes or different shapes and/or sizes. Additionally, it is noted that any number of attachment structures and/or reinforcement rib(s) can be used. The attachment structure(s) and reinforcement rib(s) can be configured to be adhered to a tooth structure, i.e., the veneer body having such structure(s) and rib(s) can be matched to a corresponding tooth structure having been reduced to mate with the cosmetic dental structure, as discussed above.

Turning now to FIG. 2, a cosmetic dental structure 10 with a rear face 12 can have a general concave rear surface. Additionally, the front face 20 can have a generally convex surface. Generally, the front face 20 of the cosmetic dental structure 10 can be shaped to resemble a tooth surface (i.e., can have the shape and/or appearance of a tooth surface). As discussed above, the cosmetic structure 10 can have a veneer body 16 with reinforcement rib(s) 14a, 14b, and/or 14c (FIG. 1) and/or attachment structure(s) 18 configured to be adhered to a tooth structure 24. In addition, an incisal rib 22 can be provided. The rear face 12 of the veneer body 16 which has the reinforcement rib(s) 14a, 14b, and/or 14c (FIG. 1), incisal rib 22, and/or the attachment structure(s) 18 can be configured to mate with a corresponding tooth structure where the tooth structure has been reduced having corresponding recessions, as further discussed below. As shown in FIG. 2, the veneer body 16, the reinforcement rib(s) 14a, 14b, and/or 14c, and/or the attachment structure(s) 18, and/or the incisal rib 22 can be a single piece and can be integrated into the veneer body.

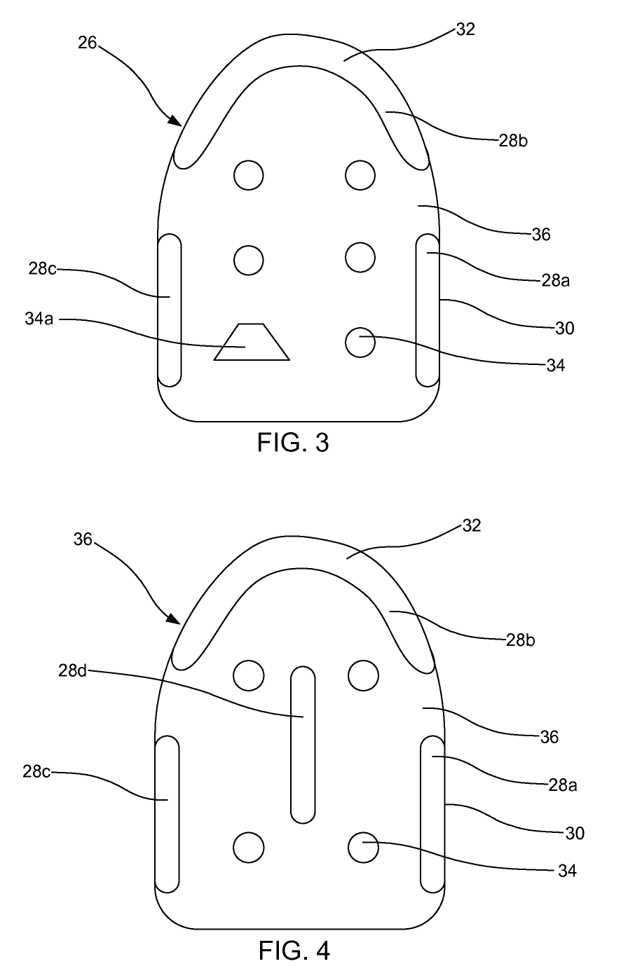

Turning now to FIG. 3, a reduced tooth 26 can have recessions 28a, 28b, and 28c along a corresponding non-gingival contour 30 and gingival contour 32 of the tooth structure positioned on the perimeter of the front face of the tooth. Additionally, the reduced tooth 26 can have the rear face of the tooth reduced along the incisal edge of the tooth (see FIG. 2). The recessions 28a, 28b, and 28c can be shaped to accommodate or match a corresponding reinforcement rib of a veneer. In one embodiment, recessions 28a, 28b, and 28c can be configured to mate with three corresponding reinforcement ribs, such as reinforcement ribs 14a, 14b, and 14c on veneer body 16, as shown in FIG. 1. In another embodiment, the recessions 28a, 28b, and 28c can form a single recession having a U-shape and configured to mate with a corresponding reinforcement rib or ribs on a veneer, as discussed above. The recessions 28a, 28b, and 28c can have a depth of about one-half of a millimeter measured from the reduced surface of a tooth structure to the bottom of the recession. Although FIG. 3 shows three recessions, a reduced tooth can have one recession, two recessions, three recessions, or more, as discussed above. Specifically, the configurations and discussion above relating to the reinforcement rib(s) and attachment structure(s) is equally applicable to the recessions described herein, and is further described below. Although the recessions described herein as well as the reduction of the front face of a tooth can be about 0.5 mm each, such reductions and recessions can have a depth more or less than 0.5 mm and can vary by the discretion of one skilled in the art.

As such, the reduced tooth can have additional recessions 34 to increase the surface area for attachment to a veneer. The additional recessions 34a can be in any general polygonal shape or another similar shape. In one embodiment the additional recessions 34 can be hemispherical. In another embodiment, the additional recessions 34 can be partially spherical or semispherical. The front face 36 of the reduced tooth 26 may be reduced about 0.5 mm. Such reduction can be in addition to forming the recessions 28a, 28b, 28c, and additional recessions 34.

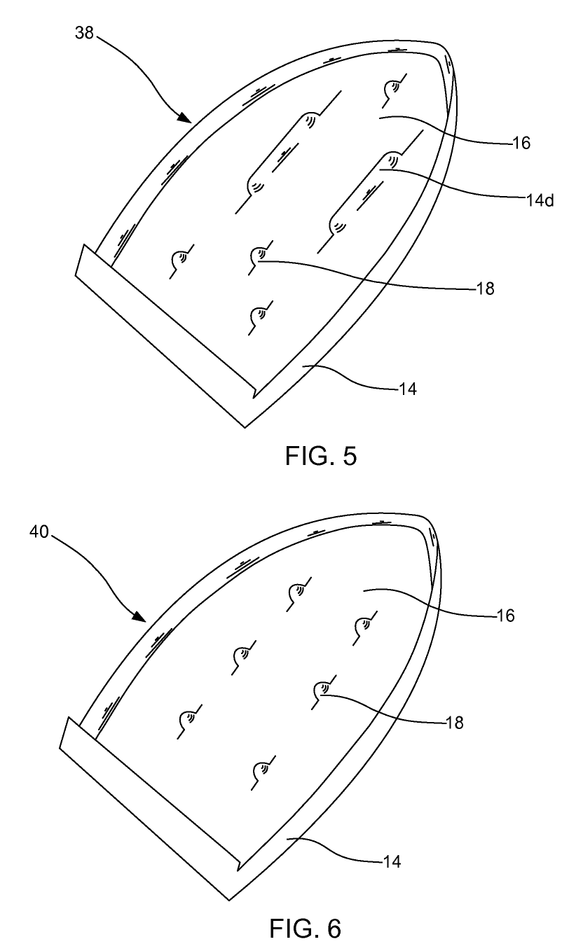

Turning now to FIG. 4, a reduced tooth 36 can have recessions 28a, 28b, 28c, and 28d where a recession 28b is positioned along a corresponding gingival contour 32, recessions 28a and 28c are positioned along a corresponding non-gingival contour 30, and a recession 28d is positioned in approximately the center of the tooth structure. Additionally, the reduced tooth 26 (FIG. 3) can have additional recessions 34. As previously discussed, the recessions 28a, 28b, 28c, 28d and 34 can be shaped to accommodate or match corresponding reinforcement ribs and attachment structures of a veneer. Notably, FIG. 4 provides an embodiment having distinct recessions along the perimeter of the tooth structure. However, one skilled in the art will recognize that multiple configurations are possible for achieving a reinforced veneer, and as such, are considered disclosed herein.

Turning now to FIG. 5, a cosmetic dental structure 38 can comprise reinforcement ribs 14 and 14d where reinforcement rib 14 is a substantially U-shaped rib positioned along the perimeter of the veneer body 16 and reinforcement ribs 14d are positioned approximately equidistant between the perimeter and the center of the veneer body 16. Notably, FIG. 5 provides an embodiment having a single reinforced rib along the perimeter of the tooth structure with additional reinforcement ribs and attachment structures.

Turning now to FIG. 6, a cosmetic dental structure 40 can comprise a single reinforcement rib 14 having a substantial U-shape positioned along the perimeter of the rear face of the veneer body 16 corresponding to the gingival and non-gingival contours of a corresponding tooth structure. Cosmetic dental structure 40 further comprises attachment structures 18 on the rear face of the veneer body 16.

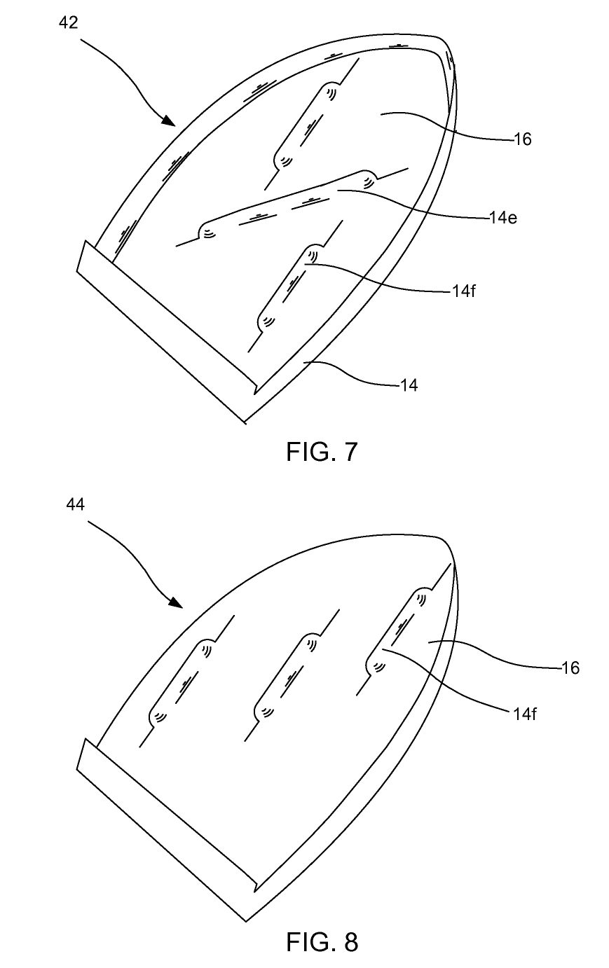

Turning now to FIG. 7, a cosmetic dental structure 42 can comprise reinforcement ribs 14, 14e, and 14f where reinforcement rib 14 is a substantially U-shaped rib positioned along the perimeter of the veneer body 16 and reinforcement ribs 14e and 14f are positioned within the central portion of the veneer body 16.

Turning now to FIG. 8, a cosmetic dental structure 44 can comprise reinforcement ribs 14f extending from the central portion of the veneer body 16. Notably, FIG. 8 provides an embodiment with no reinforcement ribs positioned along the perimeter of the veneer body 16.

Turning now to FIG. 9, a cosmetic dental structure 46 can comprise reinforcement ribs 14e, 14f, and 14g extending from the central portion of the veneer body 16 in a substantially horizontal orientation. Notably, FIG. 9 provides varying elongation of the reinforcement ribs.

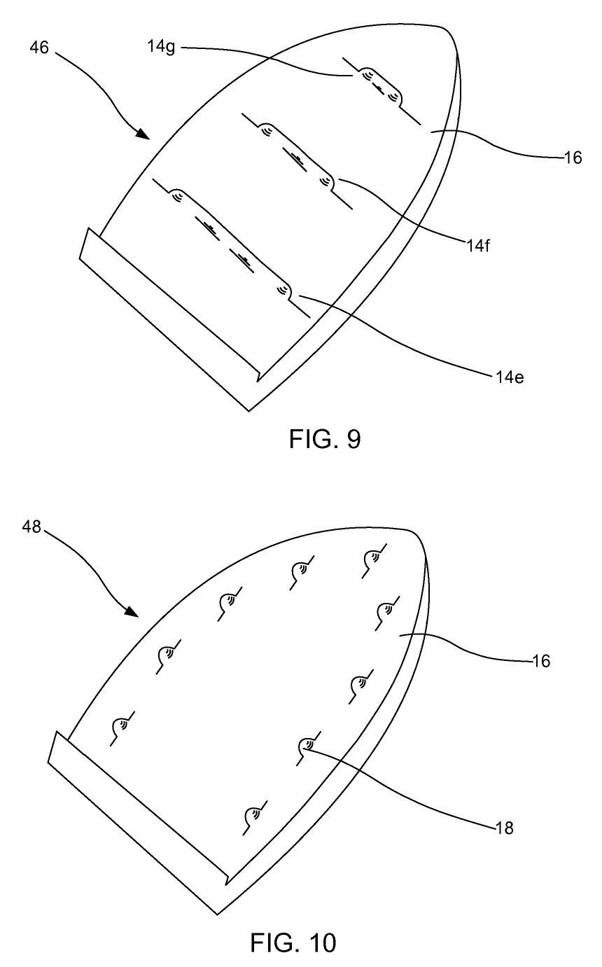

Turning now to FIG. 10, a cosmetic dental structure 48 can comprise attachment structures 18 positioned in a substantial U-shape within the central portion of the veneer body 16. In another embodiment, the attachment structures 18 can be positioned along the perimeter of the veneer body 16.

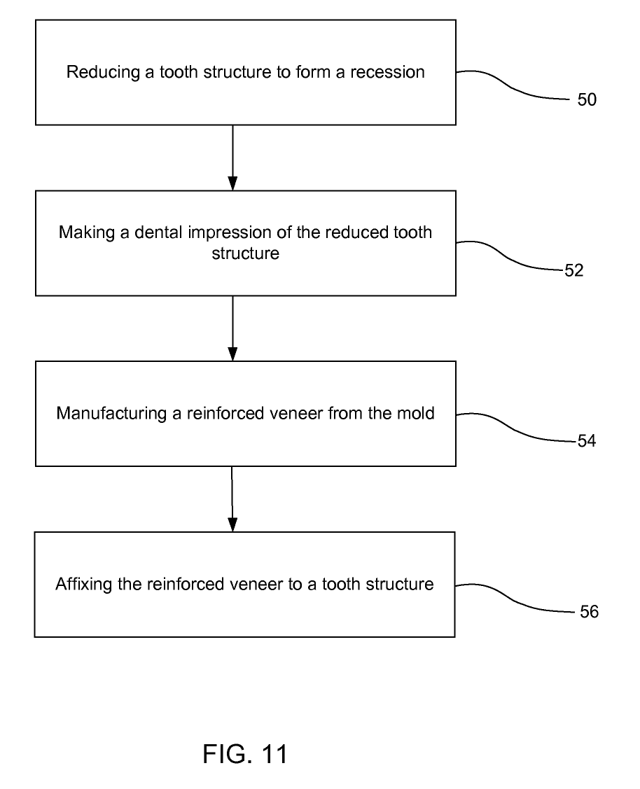

Additionally, as illustrated in FIG. 11, the present cosmetic dental structures can be formed by first reducing a tooth structure to form recessions 50 as described herein. Second, the step of making a dental impression of the reduced tooth structure 52 can be performed. Third, the step of manufacturing a reinforced veneer from the mold 54 having reinforced ribs and attachment structures on the rear face of the veneer that mate with the corresponding recessions can be performed. As such, the reinforced rib and/or attachment structures extending from the rear face of the veneer body can be based on the dental impression.

In one aspect, a method of manufacturing a veneer body for attachment to a tooth structure can comprise the operation of obtaining a dental impression of a reduced tooth structure. A further operation can be forming a reinforcement rib on a rear face of the veneer body based on the dental impression, where the reinforcement rib extends from a rear face of the veneer body and is configured to strengthen the veneer body.

Additionally, a method of affixing a cosmetic dental structure to a tooth structure can include the operation of reducing the tooth structure to form a reduced tooth structure such that a front face of the tooth structure contains a recession configured to mate with a veneer body. The veneer body can also have a reinforced rib extending from a rear face of the veneer body and the rib is configured to strengthen the veneer body. A further operation is making a dental impression of the reduced tooth structure. Then a veneer body can be obtained that has the reinforced rib extending from the rear face of the veneer body. The veneer body with the reinforced rib may be: obtained by a dental office from a lab, created on-site at the dental office or created at another location. The veneer body having the reinforced rib can be affixed to the reduced tooth structure using a dental adhesive or cement. The dentist will generally be the individual who affixes the veneer to the tooth structure but other trained individuals may also undertake this task.

While some of the above methods have been shown involving several steps, it is noted that the methods described herein do not necessarily contain each and every step and that numerous modifications may be made by one skilled in the art. As such, the methods described herein can be modified, shortened, or lengthened. For example, the previous methods can include a step of applying an ozone treatment as discussed in further detail below. Additionally, the present methods can be modified as outlined in the compositional discussion provided herein.

A temporary veneer can be manufactured using the dental impression. The temporary veneer can match the general dimensions of the tooth without the reinforcement structures described herein. The temporary veneer can be affixed to the tooth while the reinforced veneer is manufactured. This step can allow for a dentist or a subject to indentify any cosmetic or functional concerns with the general dimensions of the veneer. The temporary veneer can be temporarily affixed to the tooth and subsequently removed. Regardless of the use of a temporary veneer, a method of applying the reinforced veneer to the reduced tooth structure can comprise affixing the reinforced veneer to the matched reduced tooth structure (e.g., with dental cement) as discussed above. Notably, the affixing step can be independently performed regardless of the method of manufacturing the reinforced veneer. The present methods can provide an exact match of the veneer to the tooth structure providing improved strength as well as a matched fit. As such, the present compositions and methods described herein can provide strength and tolerance characteristics previously unachievable.

As illustrated in the FIGs., the present cosmetic dental structures can have varying configurations of reinforcement ribs and/or attachment structures in varying sizes, shapes, positioning, and/or orientations.

In an additional embodiment of the invention, ozone therapy can be used in treating teeth before they are reduced and in treating reduced teeth before the veneers are applied to the tooth structure. In addition, the ozone can be applied to the rear surface of the veneers before they are applied to the reduced tooth structure. Ozone (O₃) can be created using ozone generation machines.

There are several benefits of treating the reduced teeth with ozone prior to the reduction of the teeth. One benefit is the near sterilization of the teeth before the veneers are applied. This helps reduce the amount of bacteria that may be caught between the veneer and the reduced tooth structure. Reducing the subsurface contamination also reduces the chances that the veneer will fail due to a weakening of the subsurface bond, fail due to infection, or have other related problems. Another benefit of ozone therapy is the desensitization of the teeth during the reduction process and/or when the veneers are applied to the reduced teeth. The ozone therapy can be used in combination with known pain killers to produce the desired desensitization. Ozone therapy can also aid in reshaping the soft tissue around the tooth re-epithelisation. A further benefit of ozone therapy is the re-mineralization of the reduced tooth structure. This re-mineralization may create a stronger cementation bond between the reduced tooth and the veneer.

As such, a method of preparing a tooth for attachment to a cosmetic dental structure having a veneer body can comprise the operations of reducing a tooth structure to form a reduced tooth structure; making a dental impression of the reduced tooth structure; obtaining the veneer body based on the dental impression; applying an ozone treatment to the reduced tooth structure after reduction has taken place; and affixing the veneer body having the reinforced rib to the reduced tooth structure using a dental adhesive.

While the invention has been described with reference to certain preferred embodiments, those skilled in the art will appreciate that various modifications, changes, omissions, and substitutions can be made without departing from the spirit of the invention. It is intended, therefore, that the invention be limited only by the scope of the following claims.

1. A cosmetic dental structure, comprising:
a veneer body sized to cover at least a portion of a tooth structure;
a front face and a rear face of the veneer body; and
a reinforcement rib extending outwardly from the rear face of the veneer body, the reinforcement rib being configured to strengthen the veneer body, wherein the reinforcement rib and veneer body are configured to be adhered to the tooth structure.

2. The cosmetic dental structure of claim 1, wherein the rear face has a generally concave surface.

3. The cosmetic dental structure of claim 1, wherein the front face has a generally convex surface.

4. The cosmetic dental structure of claim 1, wherein the front face is shaped to resemble a tooth surface.

5. The cosmetic dental structure of claim 1, wherein the veneer body further comprises at least two reinforcement ribs.

6. The cosmetic dental structure of claim 5, wherein the reinforcement ribs are a single piece.

7. The cosmetic dental structure of claim 6, wherein the reinforcement ribs are integrated into the veneer body.

8. The cosmetic dental structure of claim 1, wherein the veneer body comprises at least three reinforcement ribs located along edges of the rear face of the veneer body.

9. The cosmetic dental structure of claim 8, wherein two of the ribs are substantially elongated ribs positioned to match vertical interproximal aspects on the sides of the tooth structure.

10. The cosmetic dental structure of claim 9, wherein the three ribs form a U-shape and are positioned to match corresponding gingival and non-gingival contours of the tooth structure.

11. The cosmetic dental structure of claim 1, wherein the reinforcement rib is a U-shaped rib positioned to match to a corresponding gingival contour of the tooth structure.

12. The cosmetic dental structure of claim 1, wherein the reinforcement rib is a perimeter shaped rib positioned to match to corresponding non-gingival and gingival contours of the tooth structure positioned on the perimeter of a front face of the tooth structure.

13. The cosmetic dental structure of claim 1, wherein the reinforcement rib is a perimeter shaped rib positioned to match to corresponding non-gingival and gingival contours of the tooth structure and a portion of the veneer is configured to wrap around an incisal edge of the tooth structure thereby forming a reinforced frame around the veneer body.

14. The cosmetic dental structure of claim 1, wherein a portion of the veneer body is configured to wrap around an incisal edge of the tooth, said portion of the veneer body having an incisal rib extending from the rear surface of the veneer body.

15. The cosmetic dental structure of claim 14, wherein the reinforcement rib is a perimeter shaped rib positioned to match to corresponding non-gingival and gingival contours of the tooth structure and, with the incisal rib, forms a reinforced frame around the veneer body.

16. The cosmetic dental structure of claim 1, wherein the veneer body is made of dental porcelain.

17. The cosmetic dental structure of claim 1, wherein the tooth structure to which the veneer body is configured to be adhered is a natural tooth.

18. A method of applying the cosmetic dental structure of claim 1 to the tooth structure, comprising affixing the veneer body to the tooth structure using dental cement.

19. A cosmetic dental structure, comprising:
a veneer body having a front face and a rear face; and
an attachment structure extending from the rear face of the veneer body, the attachment structure being configured to increase the surface area of the rear face of the veneer body available when affixing the veneer body to a tooth structure.

20. The cosmetic dental structure of claim 19, wherein the attachment structure has a hemispherical shape extending from the rear face of the veneer body.

21. The cosmetic dental structure of claim 19, wherein the attachment structure is also partially spherical.

22. The cosmetic dental structure of claim 19, wherein the attachment structure has a polygonal shape.

23. The cosmetic dental structure of claim 19, wherein a portion of the veneer body is configured to wrap around an incisal edge of the tooth structure, said portion of the veneer body having an incisal rib extending from the rear surface of the veneer body.

24. A method of applying the cosmetic dental structure of claim 19 to the tooth structure, comprising affixing the veneer body to the tooth structure using dental cement.

25. A cosmetic dental structure, comprising:
a veneer body sized to cover at least a portion of a tooth structure;
a front face of the veneer body;
a reinforcement rib extending from a rear face of the veneer body, the reinforcement rib being configured to strengthen the veneer body; and
an attachment structure extending from the rear face of the veneer body, the attachment structure being configured to increase the surface area of the rear face of the veneer body available when affixing the veneer body to the tooth structure, wherein the reinforcement rib, attachment structure, and veneer body are configured to be adhered to the tooth structure.
